(19) United States
(12) Patent Application Publication
(10) Pub. No.: US 2002/0084123 A1
(43) Pub. Date: Jul. 4, 2002

(54) Ice-fishing house system

(76) Inventor: Robert H. Farsdale, Jamestown, ND (US)

Correspondence Address: Michael S. Neustel, Suite No. 4, 2534 South University Drive, Fargo, ND, 58103, US

(21) Appl. No.: 09/755,756

(22) Filed: Jan. 4, 2001

(51) Int. Cl. B62M 27/02

(52) U.S. Cl. 180/182; 180/186

(57) ABSTRACT

An ice-fishing house system for providing trouble-free movement of an ice-fishing house upon various types of surfaces. The inventive device includes a frame, a plurality of rear wheels rotatably attached to the frame, a motor mechanically connected to the rear wheels, a pair of skis attached to the front portion of the frame, and a central control unit for allowing control of the ice-fishing house system. The rear wheels are attached to a rear evener arm wherein the rear evener arm is pivotally attached to a rear lifting arm. A rear cylinder is connected to the rear lifting arm to facilitate lifting and lowering of the rear portion of the frame with respect to a surface. A pair of front lifting arms are pivotally attached to the front portion of the frame and extend outwardly to support and engage the skis. A front cylinder is pivotally connected between the pair of front lifting arms to facilitate lifting and lower of the front portion of the frame with respect to a surface. In an alternative embodiment, a pair of front wheels are rotatably attached to the front lifting arms to allow the inventive device to be utilized upon various types of surfaces.

### BACKGROUND OF THE INVENTION

1. Field of the Invention

The present invention relates generally to ice houses and more specifically it relates to an ice-fishing house system for providing trouble-free movement of an ice-fishing house upon various types of surfaces.

2. Description of the Prior Art

Icehouses have been in use for years. Typically, ice-fishing houses are a stationery building put on to the ice for fishing and moved by disassembling or by physical efforts.

The problem with the conventional ice-fishing house is the time required to move the ice-fishing house. Another problem with the conventional ice-fishing house is the size of the ice-fishing house. The conventional ice-fishing house is relatively compact in size.

Examples of patented icehouses include U.S. Pat. No. 1,661,511 to Steffler; U.S. Pat. No. 1,590,453 to Staude et al.; and U.S. Pat. No. 5,137,297 to Walker are all illustrative of such prior art.

While these devices may be suitable for the particular purpose to which they address, they are not as suitable for making an ice-fishing trip more convenient and comfortable.

The problem with the conventional ice-fishing house is the time required to move the ice-fishing house. Another problem with the conventional ice-fishing house is the size of the ice-fishing house.

In these respects, the ice-fishing house system according to the present invention substantially departs from the conventional concepts and designs of the prior art, and in so doing provides an apparatus primarily developed for the purpose of making an ice-fishing trip more convenient and comfortable.

### SUMMARY OF THE INVENTION

In view of the foregoing disadvantages inherent in the known types of ice houses now present in the prior art, the present invention provides a new ice-fishing house system construction wherein the same can be utilized for to make an ice-fishing trip more convenient and comfortable.

The general purpose of the present invention, which will be described subsequently in greater detail, is to provide a new ice-fishing house system that has many of the advantages of the ice houses mentioned heretofore and many novel features that result in a new ice-fishing house system which is not anticipated, rendered obvious, suggested, or even implied by any of the prior art ice houses, either alone or in any combination thereof.

To attain this, the present invention generally comprises a frame, a plurality of rear wheels rotatably attached to the frame, a motor mechanically connected to the rear wheels, a pair of skis attached to the front portion of the frame, and a central control unit for allowing control of the ice-fishing house system. The rear wheels are attached to a rear evener arm wherein the rear evener arm is pivotally attached to a rear lifting arm. A rear cylinder is connected to the rear lifting arm to facilitate lifting and lowering of the rear portion of the frame with respect to a surface. A pair of front lifting arms are pivotally attached to the front portion of the frame and extend outwardly to support and engage the skis. A front cylinder is pivotally connected between the pair of front lifting arms to facilitate lifting and lower of the front portion of the frame with respect to a surface.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an ice-fishing house system that will overcome the shortcomings of the prior art devices.

A second object is to provide an ice-fishing house system that is used to make an ice-fishing trip more convenient and comfortable.

Another object is to provide an ice-fishing house system that can be safely moved in various winter conditions.

Another object is to provide an ice-fishing house system that is self-propelled.

An additional object is to provide an ice-fishing house system that can use removable tracks for better traction on the ice then conventional tires.

A further object is to provide an ice-fishing house system that can use skis for better control on the ice then conventional tires.

Another object is to provide an ice-fishing house system that can be towed by a vehicle when done being used.

Another object is to provide an ice-fishing house system that allows the user to fish in more spots with a lot less effort.

Another object is to provide an ice-fishing house system that allows the user to move the ice-fishing house from one lake to another easier.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with out the top framework.

FIG. 3 is a top view of the present invention.

FIG. 4 is a left side view of the present invention with the skis on the front.

FIG. 5 is a left side view of the present invention with the wheels on the front.

FIG. 6 is a front view of the present invention with the skis on in the raised position.

FIG. 7 is a front view of the present invention with the skis on being manipulated to the lowered position.

FIG. 8 is a front view of the present invention with the skis on in the lowered position.

FIG. 9 is a side view of the present invention with the skis on in the raised position.

FIG. 10 is a side view of the present invention with the skis on being manipulated to the lowered position.

FIG. 11 is a side view of the present invention with the skis on in the lowered position.

FIG. 12 is a rear side view of the present invention without the rear wheels on in the raised position.

FIG. 13 is a rear side view of the present invention without the rear wheels on being manipulated to the lowered position.

FIG. 14 is a rear side view of the present invention without the rear wheels on in the lowered position.

FIG. 15 is an upper perspective view of the present invention with wheels and tracks on.

FIG. 16 is a top view of the present invention with wheels and tracks on.

FIG. 17 is a side view of the present invention with skis and tracks on.

FIG. 18 is a side view of the present invention with wheels and tracks on.

### DESCRIPTION OF THE PREFERRED EMBODIMENT

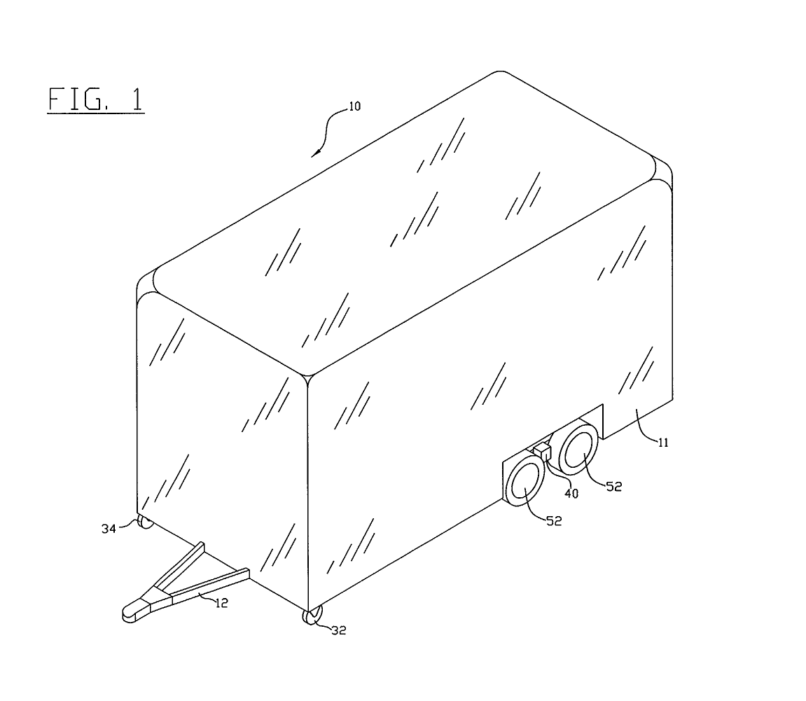

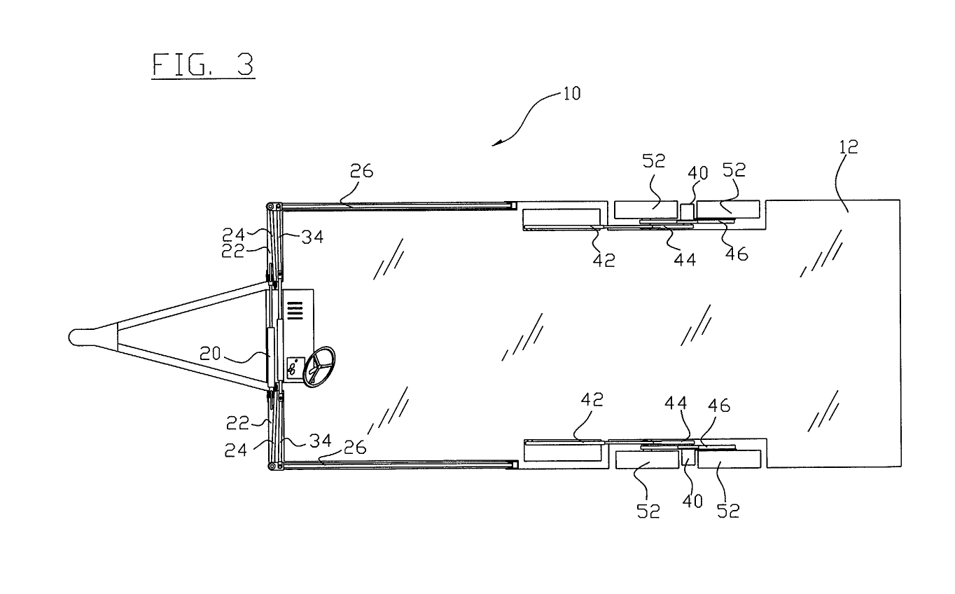

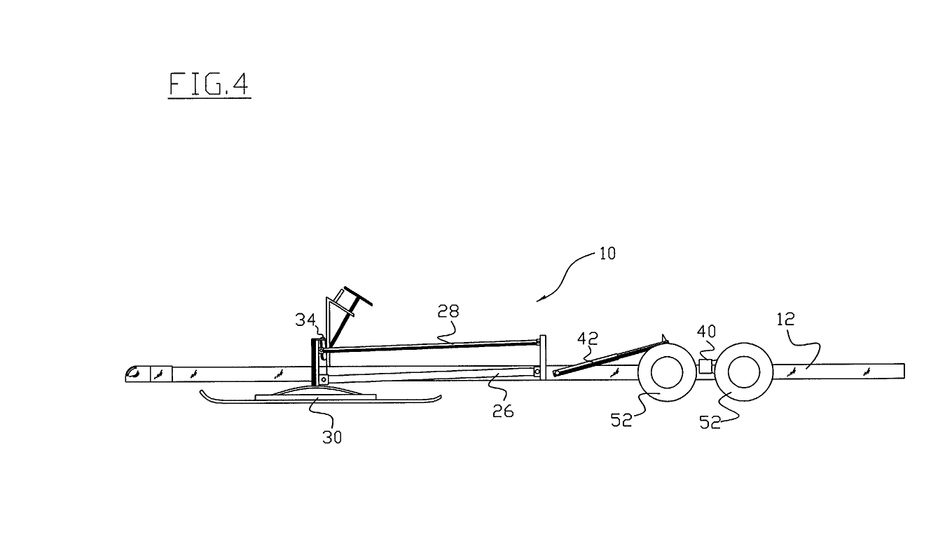

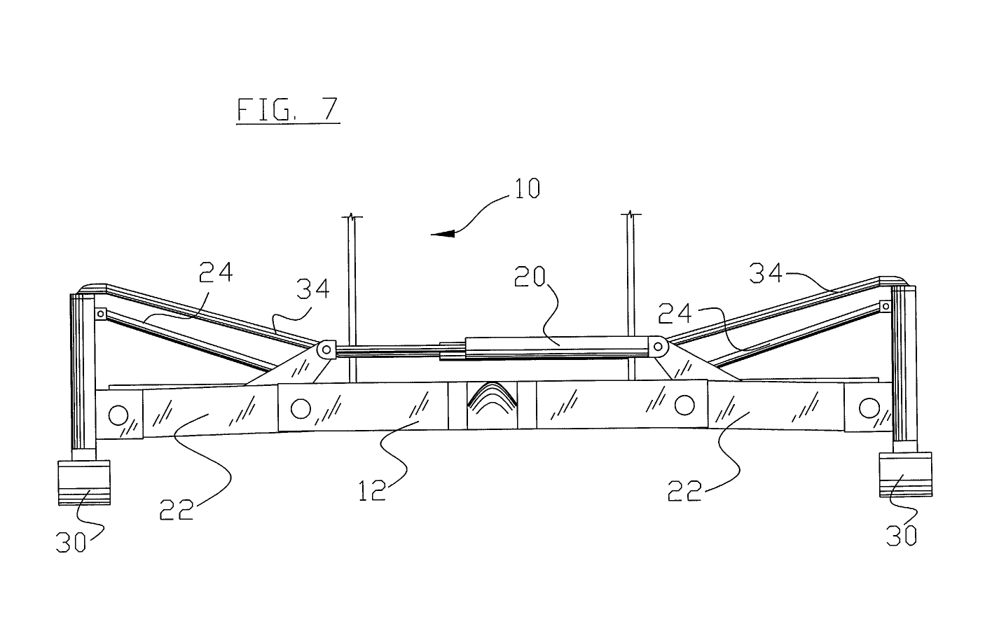

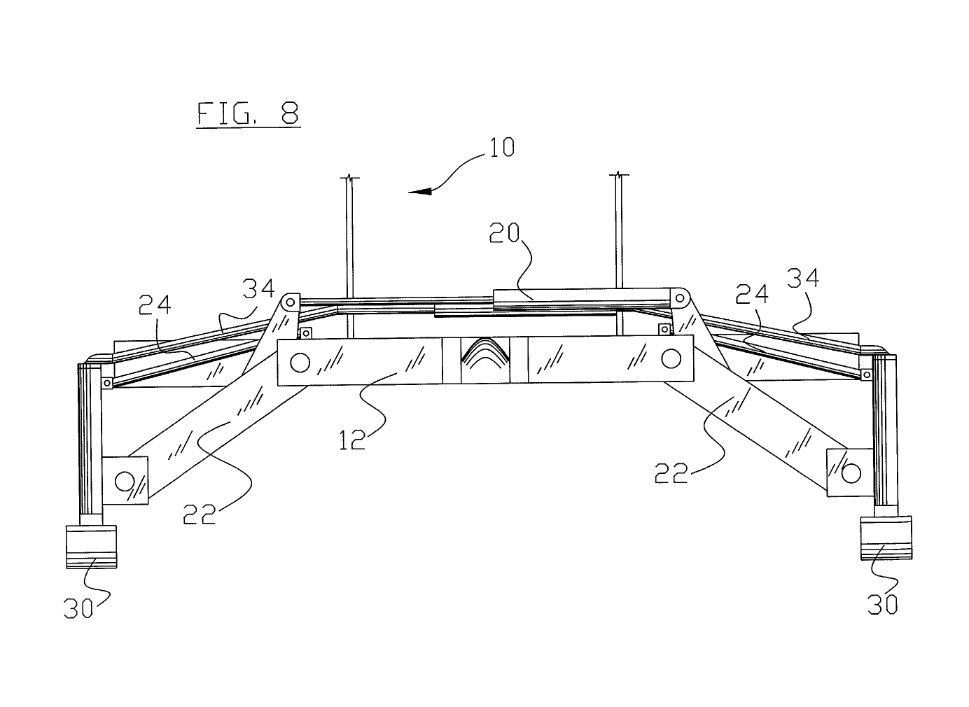

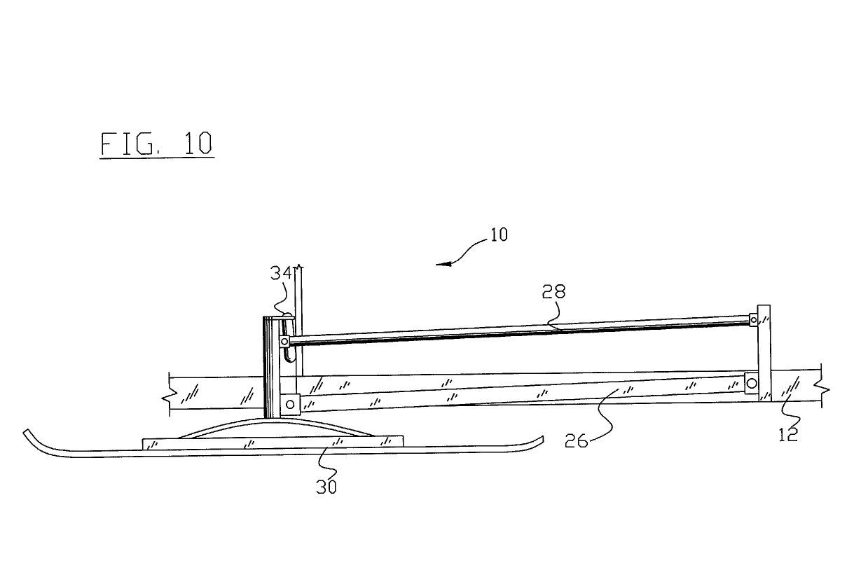

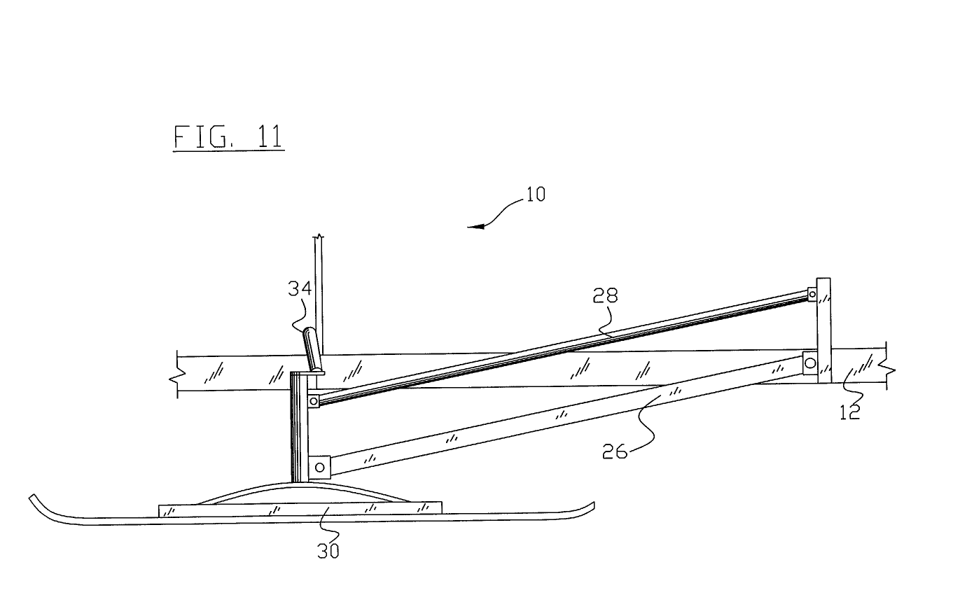

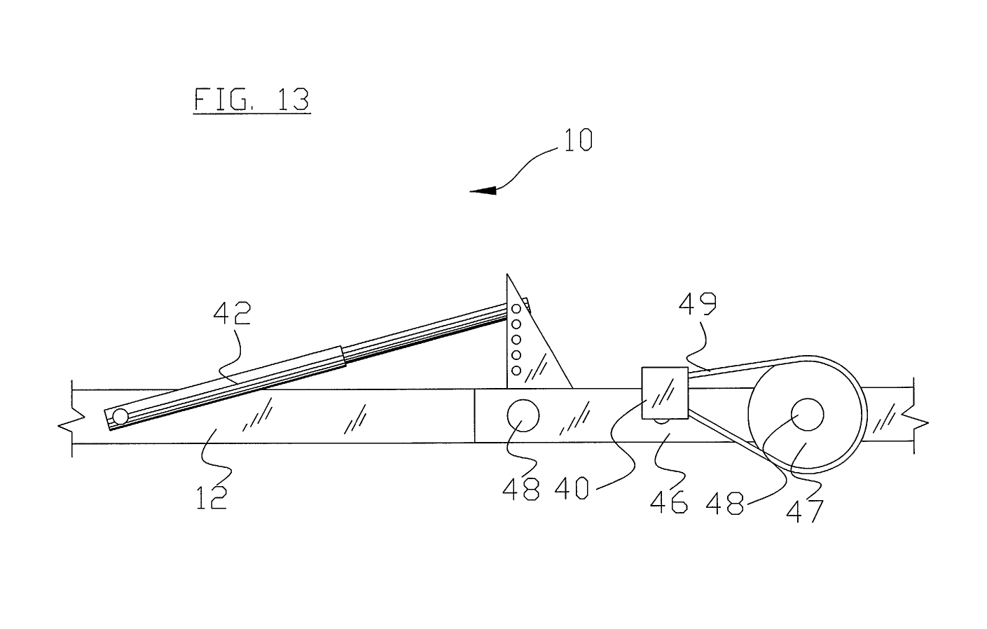

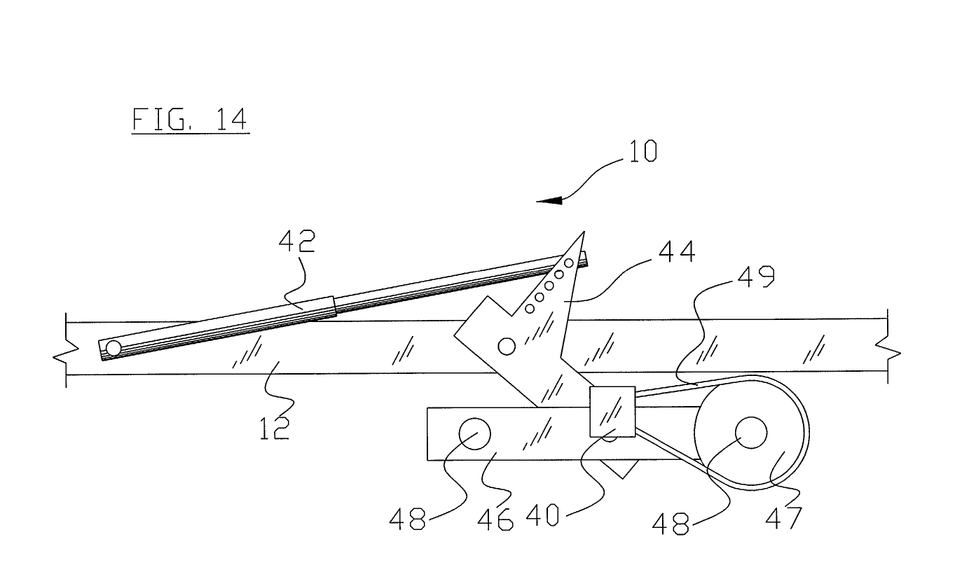

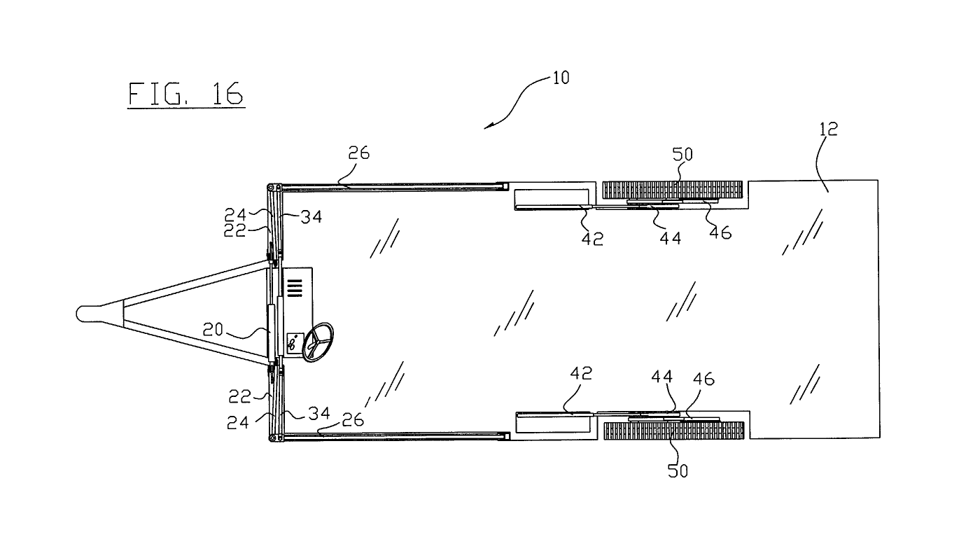

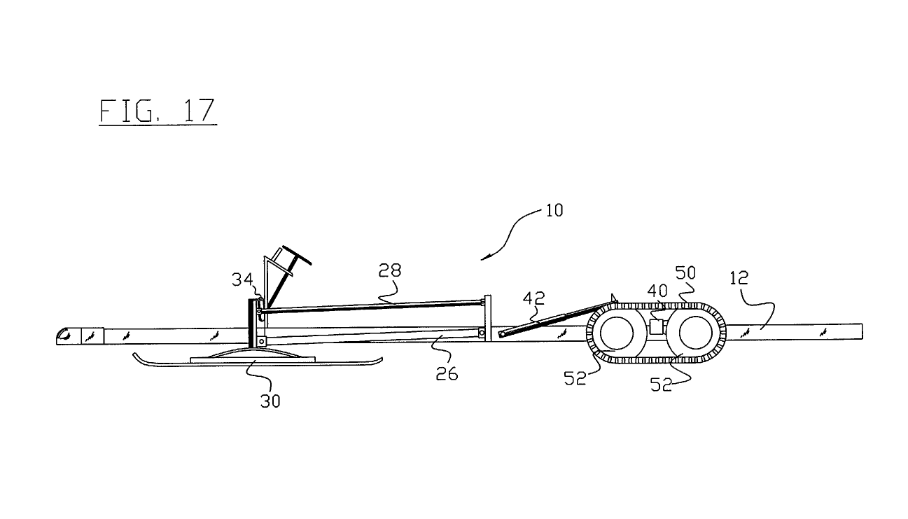

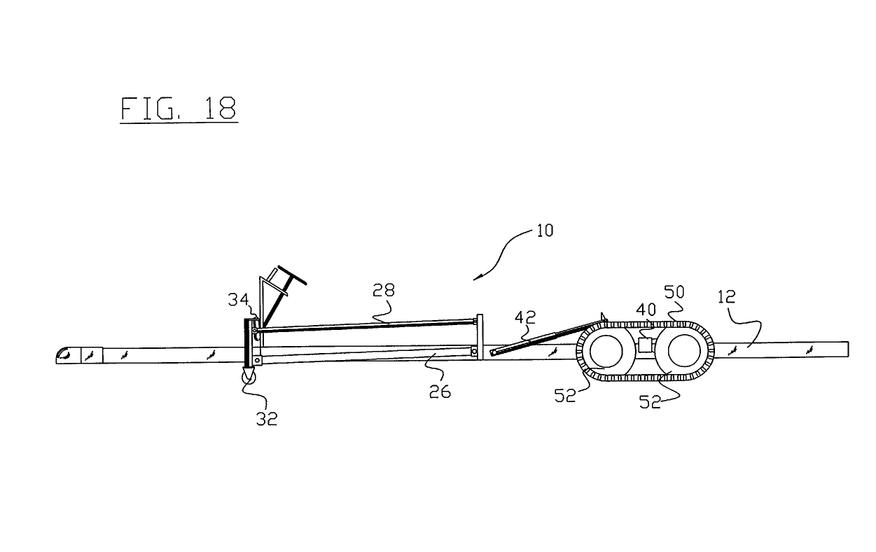

Turning now descriptively to the drawings, in which similar reference characters denote similar elements throughout the several views, FIGS. 1 through 18 illustrate an ice-fishing house system 10, which comprises a frame 12, a plurality of rear wheels 52 rotatably attached to the frame 12, a motor 40 mechanically connected to the rear wheels 52, a pair of skis 30 attached to the front portion of the frame 12, and an unnumbered central control unit for allowing control of the ice-fishing house system 10. The rear wheels 52 are attached to a rear evener arm 46 wherein the rear evener arm 46 is pivotally attached to a rear lifting arm 44. A rear cylinder 42 is connected to the rear lifting arm 44 to facilitate lifting and lowering of the rear portion of the frame 12 with respect to a surface. A pair of front lifting arms 22 are pivotally attached to the front portion of the frame 12 and extend outwardly to support and engage the skis 30. A front cylinder 20 is pivotally connected between the pair of front lifting arms 22 to facilitate lifting and lower of the front portion of the frame 12 with respect to a surface.

The front cylinder 20 is pivotally attached to the front lifting arms 22. The front cylinder 20 is typically comprised of a standard hydraulic cylinder or other actuator device. The front cylinder 20 is used to manipulate the position of the front lifting arms 22, a first front evener arm 24, a second front evener arm 26, a third front evener arm 28, and front wheels 32, or skis 30.

The front lifting arms 22 are pivotally attached to the wheels 32, or skis 30, frame 12 and front cylinder 20 in respect to the ground. The front lifting arms 22 are designed for manipulating the location of the front wheels 32, or skis 30, with respect to the surface of ground or ice.

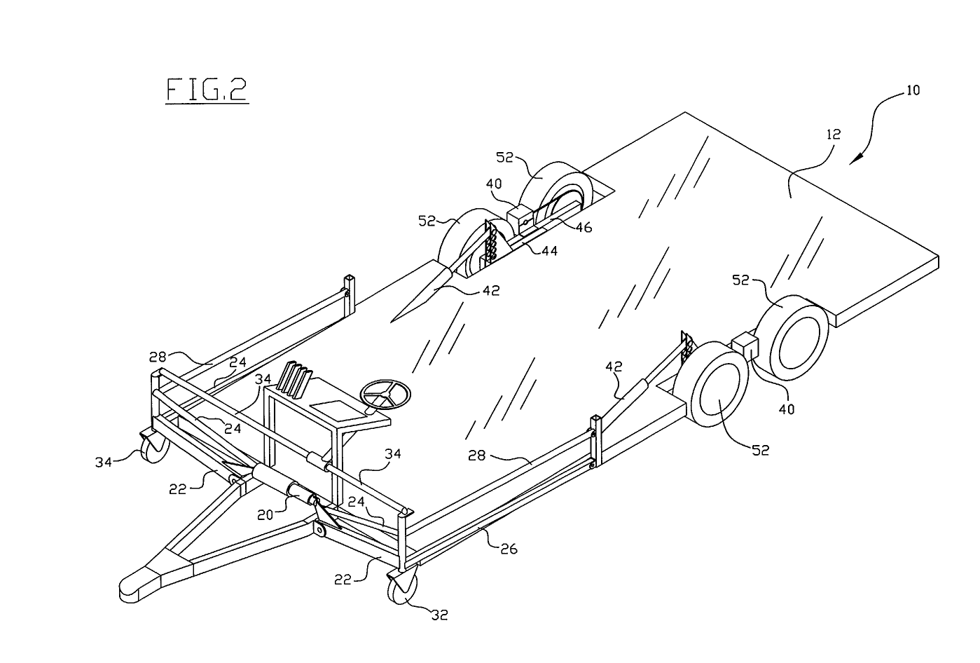

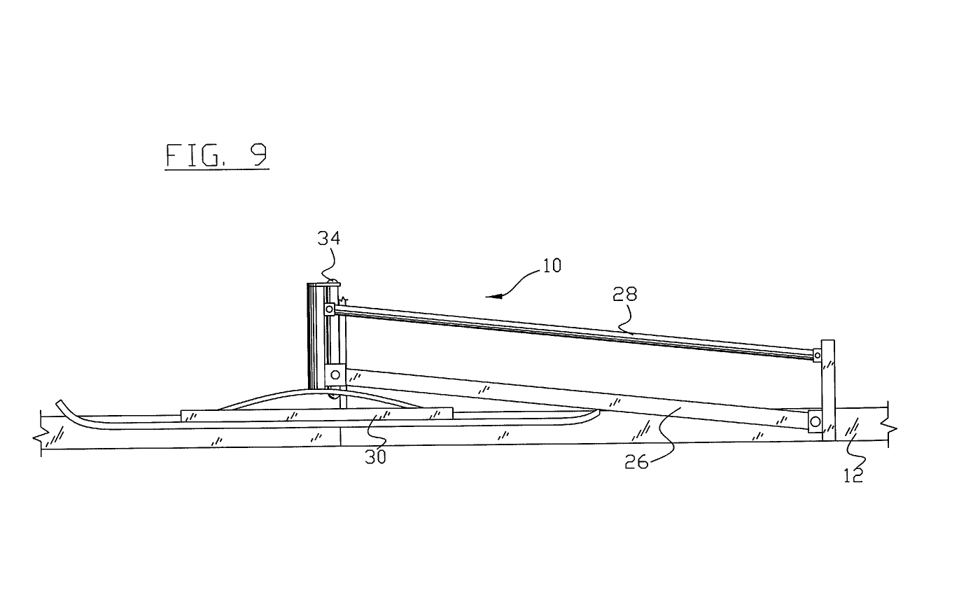

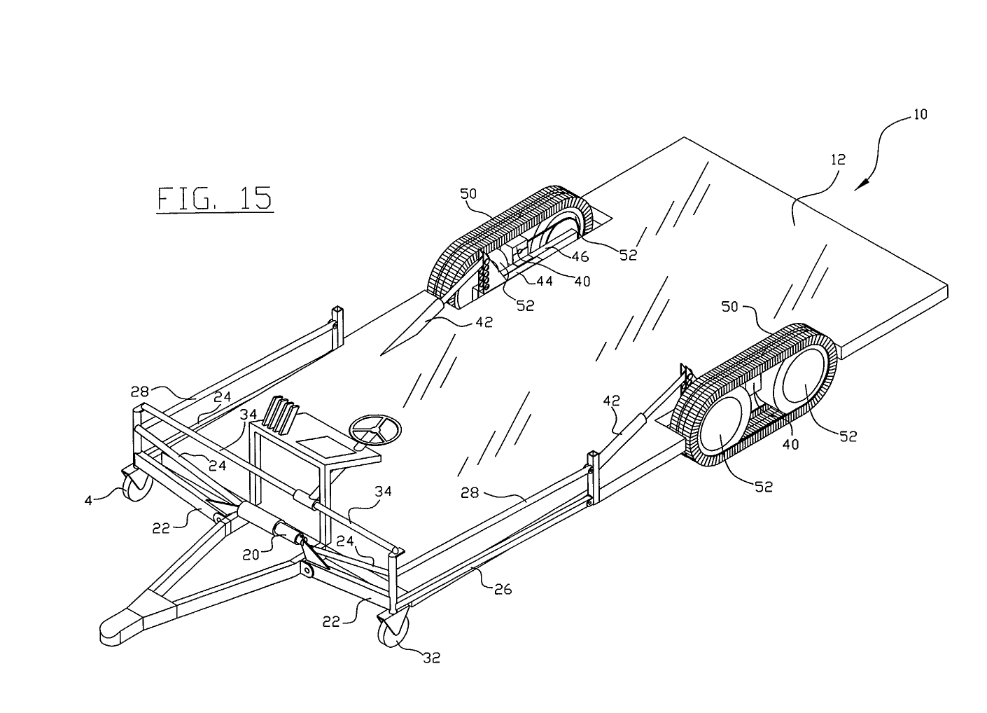

As best shown in FIGS. 2 and 15 of the drawings, a first front evener arm 24, a second front evener arm 26, and a third front evener arm 28 are pivotally attached to the frame 12 and the front wheels 32, or skis 30. The front evener arms 24, 28 are constructed to maintain the front wheels 32 or skis 30, in the vertical position while being manipulated by the user. The second front evener arm 26 is constructed to maintain the front wheels 32, or skis 32, in the vertical position while being manipulated by the user. The front evener arms 26, 28 are generally parallel to one another as best shown in FIGS. 9, 10 and 11 of the drawings.

As best shown in FIG. 9 of the drawings, the skis 30 are attached to a vertical member that is mechanically attached to the front evener arms 24, 26, 28. The skis 30 are comprised of the basic snowmobile ski design, which is used to make the horizontal movement of the ice-fishing house system 10 across the winter terrain.

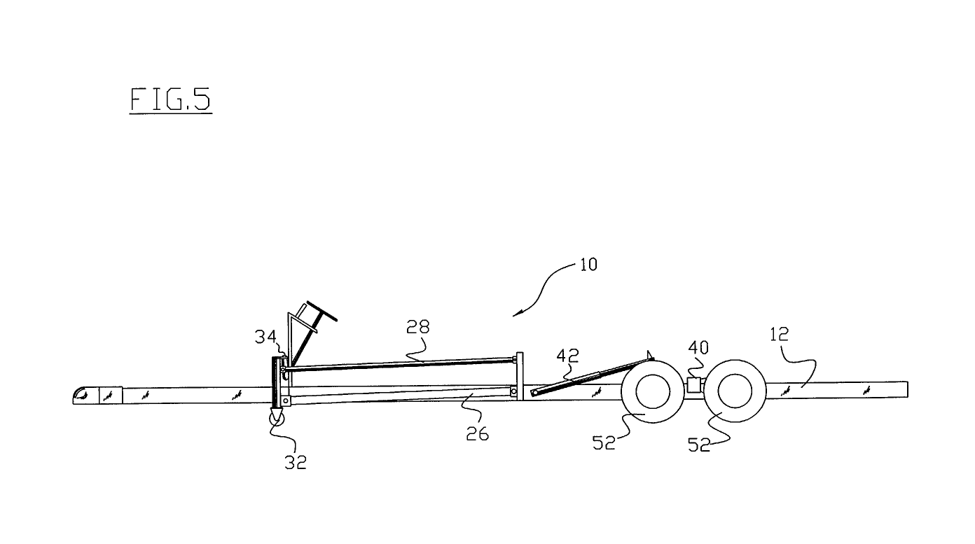

As best shown in FIGS. 5 and 15 of the drawings, the front wheels 32 are rotatably attached to a vertical member that is mechanically attached to the front evener arms 24, 26, 28. The front wheels 32 are comprised of the general caster design, which makes the movement of the ice-fishing house system 10 practical all year round. The steering linkage 34 is attached to the front wheels 32, or skis 30. The steering linkage 34 is used to turn the front wheels 32, or skis 30, while the user is controlling the ice-fishing house system 10.

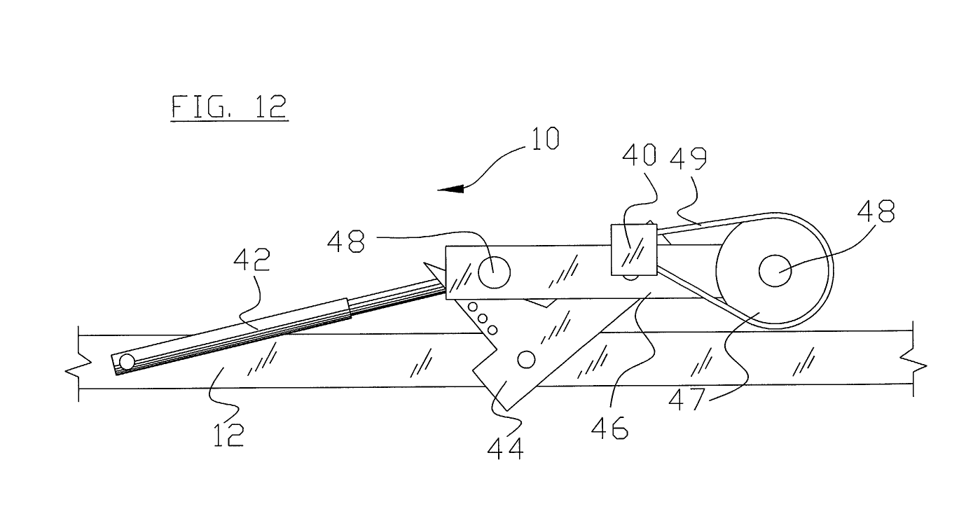

The hydraulic drive 40 is mounted to the rear evener arm 46 as best shown in FIGS. 12, 13 and 14 of the drawings. The hydraulic drive 40 is mechanically connected to the rear wheels 52 for facilitating the horizontal movement of the ice-fishing house system 10.

The drive gear 47 is attached to at least one of the drive shafts 48 as best shown in 12, 13 and 14 of the drawings. The drive gear 47 is used to manipulate the movement of the rear wheels 52, or tracks 50. The drive shafts 48 are attached to the rear evener arm 46, and the rear wheels 52, at least one of the drive shafts 48 are attached to the drive gear 47. The drive shaft 48 supports the drive gear 47 and the rear wheels 50 perpendicular to the frame 15 while allowing them to turn. The drive chain 49 is attached to the hydraulic drive 40 and drive gear 47. The drive chain 49 is used to manipulate the movement of the drive gear 47, drive shafts 48, rear wheels 52, or tracks 50.

As best shown FIG. 15 of the drawings, the tracks 50 are removably positionable about the rear wheels 52. The tracks 50 are used to increase the traction on the surface being driven upon. The rear wheels 52 are mounted on the drive shafts 48. The rear wheels 52 are generally comprised of a conventional wheel and rim combination. The rear wheels 52 are used to manipulate the horizontal movement of the ice-fishing house system 10.

The rear hydraulic cylinder 42 is pivotally attached to the frame 12 and the rear-lifting arm 44. The rear hydraulic cylinder 42 is generally comprised of a hydraulic cylinder. The rear hydraulic cylinder 42 is used to manipulate the position of the rear-lifting arm 44 in respects to the ground.

The rear-lifting arm 44 is pivotally attached to the frame 12, rear hydraulic cylinder 42, and rear evener arm 46. The rear-lifting arm 44 is used to manipulate the position of the rear evener arm 46 in respect to the ground. The rear evener arm 46 is pivotally attached to the rear-lifting arm 44 and contains the drive shafts 48. The rear evener arm 46 is used to even out the position of the dive gear 47, drive shafts 48, the drive chain 49, the tracks 50, and the rear wheels 52 in respect to the ground.

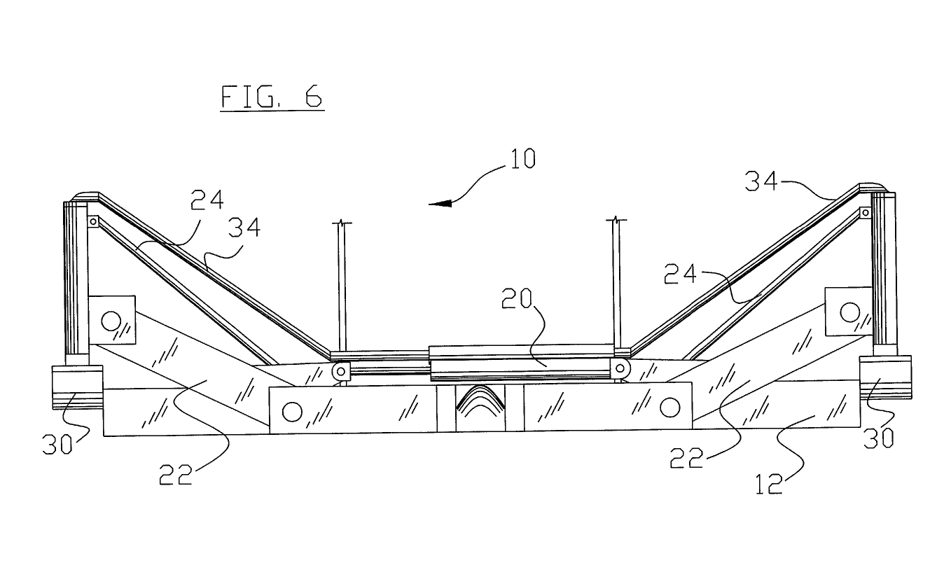

In use, the front wheels 32, or skis 30, are lowered by the extension of the front cylinder 20. With the extension of the front cylinder 20 the front lifting arms 22 that pivotally rotate with respects to the frame 12 move closer to the ground forcing the front wheels 32, or skis 30, to shift towards the ground and raise the frame 12 in a vertical position, when the front wheels 32, or skis 30, contact the ground. While the front cylinder 20 and the front lifting arms 22 are being manipulated the evener arms 24, 26, 28 are manipulating the location of the front wheels 32, or skis 30, to maintain a perpendicular pose in respect to the frame 12. While the steering linkages 34 are adjusting to the manipulation of the front wheels 32, or skis 30, so the user is capable of manipulate the front wheels 32, or skis 30 throughout the manipulation. This can be best seen in FIGS. 6, 7, 8.

While lowering the front wheels 32, or skis 30, are raised by the retraction of the front cylinder 20. With the retraction of the front cylinder 20 the front lifting arms 22 that pivotally rotate with respects to the frame 12 move further from the ground forcing the front wheels 32, or skis 30, to shift away from the ground while lowering the frame 12 in a vertical position, until the front wheels 32, or skis 30, are removed from the ground. While the front cylinder 20 and the front lifting arms 22 are being manipulated the evener arms 24, 26, 28 are manipulating the location of the front wheels 32, or skis 30, to maintain a perpendicular pose in respect to the frame 12. While the steering linkages 34 are adjusting to the manipulation of the front wheels 32, or skis 30, the user is capable of manipulating the front wheels 32, or skis 30 as desired.

The rear wheels 52, or tracks 50, are lowered by the extension of the rear cylinder 42. The extension of the rear cylinder 42 manipulates the position of the rear-lifting arm 44 in turn manipulating the rear evener arm 46. This manipulation can be best seen in FIGS. 12, 13, 14, during the manipulation the rear evener arm 46 constantly maintaining position parallel to the ground allowing the ice-fishing house system 10 to be moved in the horizontal position until the frame 12 has contacted the ground. The manipulation of the rear evener arm 46 in turn manipulates the drive shafts 48, the hydraulic drive 40, the drive gear 47, the drive chain 49, the rear wheels 52, and the tracks 50 when attacked to the rear wheels 52 which are all connected to the drive shafts 48 contained in the rear evener arm 46.

The rear wheels 52, or tracks 50, are raised by the retraction of the rear cylinder 42. The retraction of the rear cylinder 42 manipulates the position of the rear-lifting arm 44 in turn manipulating the rear evener arm 46. This manipulation can be best seen in FIGS. 12, 13, 14, during the manipulation the rear evener arm 46 constantly maintaining position parallel to the ground allowing the ice-fishing house system 10 to be moved in the horizontal position as soon as the frame 12 no longer has contact with the ground. The manipulation of the rear evener arm 46 in turn manipulates the drive shafts 48, the hydraulic drive 40, the drive gear 47, the drive chain 49, the rear wheels 52, and the tracks 50 when attacked to the rear wheels 52 which are all connected to the drive shafts 48 contained in the rear evener arm 46.

The movement of the rear wheels 52, or tracks 50 if attached, is done by the manipulation of the hydraulic drive 40. With the manipulation of the hydraulic drive 40 the drive chain 49 rotates the drive gear 47. The drive gear 47 is connected to the drive shaft 48 of at least one of the rear wheels 52 allowing the rear wheels 52, or tracks 50 if attached, to turn. The directions of the rear wheels 52, or tracks 50 if attached, movements are directly dependent on the direction the hydraulic drive 40 is manipulated.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An ice-fishing house system, comprising:
a frame having a front portion and a rear portion;
a plurality of rear wheels rotatably attached to said rear portion of said frame;
a motor mechanically connected to said plurality of rear wheels; and
a front support structure attached to said front portion of said frame.

2. The ice-fishing house system of claim 1, wherein said front support structure is comprised of a plurality of skis.

3. The ice-fishing house system of claim 1, wherein said front support structure is comprised of a plurality of wheels.

4. The ice-fishing house system of claim 1, wherein said plurality of rear wheels are mechanically connected to said rear portion of said frame by an elevating structure that elevates and lowers said plurality of rear wheels.

5. The ice-fishing house system of claim 4, wherein said elevating structure is comprised of:
a rear lifting arm pivotally attached to said frame;
a rear actuator mechanically connected between said frame and rear lifting arm for facilitating pivoting of said rear lifting arm with respect to said frame; and
a rear evener arm pivotally attached to said rear lifting arm opposite of said rear actuator, wherein said rear evener arm rotatably supports said plurality of rear wheels.

6. The ice-fishing house system of claim 5, wherein said rear evener arm includes a front end, a rear end, and a pivot point, wherein at least one of said plurality of rear wheels is positioned between said front end and said pivot point and wherein at least one of said plurality of rear wheels is positioned between said rear end and said pivot point of said rear evener arm.

7. The ice-fishing house system of claim 6, wherein said motor is attached to said rear evener arm.

8. The ice-fishing house system of claim 1, wherein said front support structure is comprised of:
a pair of vertical members;
a pair of front lifting arms pivotally attached between said pair of vertical members and said front portion of said frame; and
a front actuator extending between said pair of front lifting arms.

9. The ice-fishing house system of claim 8, including a pair of front evener arms pivotally attached between said pair of vertical members and said frame.

10. The ice-fishing house system of claim 9, including two pairs of side evener arms pivotally attached between said pair of vertical members and said frame, wherein said two pairs of side evener arms extend forwardly from said frame.

11. An ice-fishing house system, comprising:
a frame having a front portion and a rear portion;
a plurality of rear wheels rotatably attached to said rear portion of said frame;
a motor mechanically connected to said plurality of rear wheels;
a front support structure attached to said front portion of said frame; and
a hitch attached to said front portion of said frame for allowing attachment to a vehicle.

12. The ice-fishing house system of Claim 11, wherein said front support structure is comprised of a plurality of skis.

13. The ice-fishing house system of claim 11, wherein said front support structure is comprised of a plurality of wheels.

14. The ice-fishing house system of claim 11, wherein said plurality of rear wheels are mechanically connected to said rear portion of said frame by an elevating structure that elevates and lowers said plurality of rear wheels.

15. The ice-fishing house system of claim 14, wherein said elevating structure is comprised of:
a rear lifting arm pivotally attached to said frame;
a rear actuator mechanically connected between said frame and rear lifting arm for facilitating pivoting of said rear lifting arm with respect to said frame; and
a rear evener arm pivotally attached to said rear lifting arm opposite of said rear actuator, wherein said rear evener arm rotatably supports said plurality of rear wheels.

16. The ice-fishing house system of claim 15, wherein said rear evener arm includes a front end, a rear end, and a pivot point, wherein at least one of said plurality of rear wheels is positioned between said front end and said pivot point and wherein at least one of said plurality of rear wheels is positioned between said rear end and said pivot point of said rear evener arm.

17. The ice-fishing house system of claim 16, wherein said motor is attached to said rear evener arm.

18. The ice-fishing house system of claim 11, wherein said front support structure is comprised of:
a pair of vertical members;
a pair of front lifting arms pivotally attached between said pair of vertical members and said front portion of said frame; and
a front actuator extending between said pair of front lifting arms.

19. The ice-fishing house system of claim 18, including a pair of front evener arms pivotally attached between said pair of vertical members and said frame.

20. The ice-fishing house system of claim 19, including two pairs of side evener arms pivotally attached between said pair of vertical members and said frame, wherein said two pairs of side evener arms extend forwardly from said frame.
